(19) United States
(12) Patent Application Publication
(10) Pub. No.: US 2026/0145315 A1
(43) Pub. Date: May 28, 2026

(54) COLLABORATIVE ROBOT SYSTEM

(71) Applicant: AISAN KOGYO KABUSHIKI KAISHA, Obu-shi (JP)

(72) Inventors: Taisuke KAGAU, Kariya-shi (JP); Ryosuke MIYACHI, Komaki-shi (JP); Shinji KAWAI, Gifu-shi (JP); Masahi OZEKI, Obu-shi (JP); Yoshihiro SAKUMA, Kariya-shi (JP); Yuma KAKO, Nagoya-shi (JP); Shoichiro SATO, Mizuho-shi (JP)

(21) Appl. No.: 19/396,673

(22) Filed: Nov. 21, 2025

(30) Foreign Application Priority Data
Nov. 25, 2024 (JP) 2024-204902

(51) Int. Cl. B25J 9/00; B25J 5/00; B25J 19/00; G07C 1/02

(52) U.S. Cl. CPC B25J 9/0003; B25J 5/007; B25J 19/005; G07C 1/02

(57) ABSTRACT

A collaborative robot system may include a collaborative robot including a working robot mounted on a movable platform, wherein the collaborative robot is movable with a user to predetermined locations; a receiving unit configured to receive identification information of the user; a memory unit storing the identification information of the user; and a control unit configured to control the movable platform. The control unit may permit the movable platform to move in a case where identification information received by the receiving unit matches the identification information stored in the memory unit.

### CROSS REFERENCE TO RELATED APPLICATION

This application claims priority to Japanese Patent Application No. 2024-204902 filed on Nov. 25, 2024. The entire content of the priority application is incorporated herein by reference.

### TECHNICAL FIELD

The disclosure herein relates to a collaborative robot system.

### BACKGROUND ART

Japanese Patent Application Publication No. 2005-022029 describes a customer service robot system. This robot system assigns IDs to users in advance, and when receiving a user ID, it performs an action corresponding to the user. This robot system stores detail information associated with each of the user IDs in a server, and when receiving a user ID, it reads out the associated detail information from the server and performs an action corresponding to the user.

In the field of robot systems, collaborative robots are known that are configured to move a robot system to a predetermined location and work with a user. Such a collaborative robot is often used by multiple users. Thus, it is important to manage usage records of a collaborative robot, such as who moved it to which location. However, the technology described in Japanese Patent Application Publication No. 2005-022029 cannot manage usage records of a collaborative robot. The disclosure herein aims to provide a technology for managing usage records of a collaborative robot.

### SUMMARY

In a first aspect of the technology disclosed herein, a collaborative robot system may comprise a collaborative robot comprising a working robot mounted on a movable platform, wherein the collaborative robot is movable with a user to predetermined locations; a receiving unit configured to receive identification information of the user; a memory unit storing the identification information of the user; and a control unit configured to control the movable platform. The control unit may permit the movable platform to move in a case where identification information received by the receiving unit matches the identification information stored in the memory unit.

### BRIEF DESCRIPTION OF DRAWINGS

FIG. 1 illustrates a schematic diagram of a collaborative robot system.

### DETAILED DESCRIPTION

In a first aspect of the technology disclosed herein, a collaborative robot system may comprise a collaborative robot comprising a working robot mounted on a movable platform, wherein the collaborative robot is movable with a user to predetermined locations; a receiving unit configured to receive identification information of the user; a memory unit storing the identification information of the user; and a control unit configured to control the movable platform. The control unit may permit the movable platform to move in a case where identification information received by the receiving unit matches the identification information stored in the memory unit.

According to the first aspect, the movable platform is permitted to move when the user identification information stored in advance is received, which prevents a third party to which identification information has not been assigned from moving the collaborative robot. This prevents an unauthorized third party from moving the collaborative robot to an unintended location. Further, since user identification information is received, it is possible to identify who moved the collaborative robot, thereby facilitating management of usage records of the collaborative robot.

In a second aspect of the technology disclosed herein according to the first aspect, the working robot may comprise an operation unit controlled by the control unit. The control unit may permit the operation unit to operate in the case where identification information received by the receiving unit matches the identification information stored in the memory unit.

According to the second aspect, users of the working robot can be limited. Thus, anyone to which identification information has not been assigned is not only unable to move the collaborative robot, but also cannot operate the working robot at the location where the collaborative robot is present. This further facilitates management of usage records of the collaborative robot.

In a third aspect of the technology disclosed herein according to the second aspect, the memory unit may store the identification information of the user in association with an operating time of the operation unit.

According to the third aspect, it is possible to identify which user used the working robot at which time. Thus, for example, in the event of malfunction of the working robot, it is possible to identify the user and ask the user the operating conditions under which the working robot was used. This further facilitates management of usage records of the collaborative robot.

In a fourth aspect of the technology disclosed herein according to any of the first to third aspects, the collaborative robot system may further comprise a solar cell, and the solar cell may supply power to at least one of the receiving unit and the control unit.

According to the fourth aspect, power consumption from the public utility grid can be reduced.

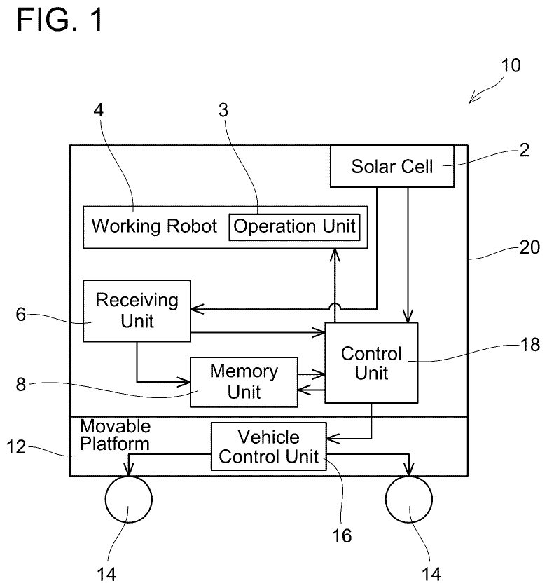

Referring to FIG. 1, a collaborative robot system 10 is described. The collaborative robot system 10 moves with a user to, for example, manufacturing locations (predetermined locations) within a factory or the like and can be used to move and/or inspect workpieces. The collaborative robot system 10 comprises a movable platform 12 and a collaborative robot 20 mounted on the movable platform 12.

The movable platform 12 comprises a wheel control unit 16 and wheels 14. The wheel control unit 16 is configured to switch the wheels 14 between a movable state and a non-movable state. When the wheels 14 are in the movable state, the movable platform 12 can move. In contrast, when the wheels 14 are in the non-movable state, the movable platform 12 cannot move. Users can move the collaborative robot 20 to manufacturing locations only when the wheels 14 are in the movable state. The switching between the movable state and the non-movable state by the wheel control unit 16 is controlled by a control unit 18. The control unit 18 will be detailed later.

The collaborative robot 20 comprises a solar cell 2, a receiving unit 6, the control unit 18, a memory unit 8, and a working robot 4. The working robot 4 comprises an operation unit 3. The solar cell 2 supplies power to the receiving unit 6 and the control unit 18. The power generated by the solar cell 2 may be directly supplied to the receiving unit 6 and the control unit 18 or may be stored in a battery (not illustrated) located within the collaborative robot 20 and supplied to the receiving unit 6 and the control unit 18 from the battery.

The receiving unit 6 is configured to receive identification information (IDs) stored in ID cards owned by users. Identification information received by the receiving unit 6 is transmitted to the control unit 18. The control unit 18 refers to the memory unit 8 to determine whether the received identification information indicates a person who is allowed to use the collaborative robot 20. In case the received identification information matches identification information stored in the memory unit 8, the control unit 18 transmits an enable signal to each of the wheel control unit 16 and the operation unit 3. The memory unit 8 stores identification information assigned to users of the collaborative robot 20. To register a new user of the collaborative robot 20, the identification information of the new user is read by the receiving unit 6 and registered in the memory unit 8.

In response to receiving the enable signal from the control unit 18, the wheel control unit 16 switches the wheels 14 to the movable state. As a result, the user can move the movable platform 12 (the collaborative robot 20) to a manufacturing location. Before receiving the enable signal from the control unit 18, the wheel control unit 16 maintains the wheels 14 in the non-movable state. Thus, anyone who is not allowed to use the collaborative robot 20 cannot move the movable platform 12 (the collaborative robot 20).

In response to receiving the enable signal from the control unit 18, the operation unit 3 switches to an operation-enabled state and the working robot 4 can operate. Thus, the user can use the working robot 4 at the manufacturing location. The operation of the working robot 4 is controlled by the control unit 18. Before receiving the enable signal from the control unit 18, the operation unit 3 maintains the working robot 4 in an operation-disabled state. Thus, anyone who is not allowed to use the collaborative robot 20 cannot operate the working robot 4.

After the operation unit 3 switches to the operation-enabled state, the memory unit 8 stores the operation start time and operating time of the operation unit 3 (the working robot 4) in association with the identification information. Thus, the owner (administrator) of the collaborative robot system 10 can check the date and time at which the collaborative robot system 10 was used, the usage period and the user. For example, in the event of malfunction of the working robot 4, the owner (administrator) of the collaborative robot system 10 can identify the user and ask the user about the conditions under which the working robot 4 was used.

The collaborative robot system 10 has advantages described hereinafter. In the collaborative robot system 10, the receiving unit 6 receives identification information assigned to a user of the collaborative robot 20, and only when the received identification information matches identification information stored in the memory unit 8, the user can move the collaborative robot 20 and operate the working robot 4. This prevents anyone who is not allowed to use the collaborative robot 20 from moving the collaborative robot 20 and operating the working robot 4.

In the collaborative robot system 10, the dates and times at which the working robot 4 operated are stored in association with identification information. Thus, the owner (administrator) of the collaborative robot system 10 can identify which user used the collaborative robot system 10 and when it was used, thereby facilitating management of usage records of the collaborative robot system 10.

### Other Embodiments

In the above embodiment, the solar cell supplies power to the receiving unit and the control unit, however, the solar cell may supply power only to the receiving unit or only to the control unit. Further, in the technology disclosed herein, the solar cell is not a necessary component and may be omitted.

In the above embodiment, the control unit transmits an enable signal to each of the operation unit (the working robot) and the wheel control unit when identification information received by the receiving unit matches identification information stored in the memory unit. However, the control unit may transmit an enable signal only to the wheel control unit without transmitting an enable signal to the operation unit. Even in this case, anyone who is not allowed to use the collaborative robot cannot move the collaborative robot (the movable platform) and only the authorized persons (users) can move the collaborative robot (the movable platform). This prevents inconveniences such as the collaborative robot being moved to an unintended location.

In the above embodiment, the memory unit stores identification information of users in association with the operating time and the like of the operation unit (the working robot). However, in the technology disclosed herein, storing identification information of users in association with the operating time and the like of the operation unit (the working robot) is not necessary and may be omitted.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is

1. A collaborative robot system comprising:
a collaborative robot comprising a working robot mounted on a movable platform, wherein the collaborative robot is movable with a user to predetermined locations;
a receiving unit configured to receive identification information of the user;
a memory unit storing the identification information of the user; and
a control unit configured to control the movable platform, and
wherein the control unit permits the movable platform to move in a case where identification information received by the receiving unit matches the identification information stored in the memory unit.

2. The collaborative robot system according to claim 1,
wherein the working robot comprises an operation unit controlled by the control unit, and
wherein the control unit permits the operation unit to operate in the case where identification information received by the receiving unit matches the identification information stored in the memory unit.

3. The collaborative robot system according to claim 2, wherein the memory unit stores the identification information of the user in association with an operating time of the operation unit.

4. The collaborative robot system according to claim 1, further comprising a solar cell,
wherein the solar cell supplies power to at least one of the receiving unit and the control unit.
